(19) United States
(12) Patent Application Publication
(10) Pub. No.: US 2022/0077441 A1
(43) Pub. Date: Mar. 10, 2022

(54) BATTERY SYSTEM FOR INDUSTRIAL MACHINE

(71) Applicant: Caterpillar Inc., Peoria, IL (US)

(72) Inventors: Justin D. MIDDLETON, Peoria, IL (US); Jonathan M. BAUMANN, Hanna City, IL (US)

(73) Assignee: Caterpillar Inc., Peoria, IL (US)

(21) Appl. No.: 17/016,013

(22) Filed: Sep. 9, 2020

(51) Int. Cl. H01M 2/10; H01M 2/20; B60L 50/60; B60K 1/04

(52) U.S. Cl. CPC H01M 2/1077; H01M 2/20; B60L 50/66; B60K 2001/0416; H01M 2220/20; B60L 2200/40; B60K 1/04

(57) ABSTRACT

In one example, a battery housing assembly may be provided in an industrial vehicle, and the battery housing assembly may include a battery housing having a top, bottom, and opposite sides, and a length, a width, and a height, the length and width extending between the opposite sides, and the height extending from the top to the bottom of the battery housing; a plate extending substantially the entire length and height of the battery housing; and a plurality of battery modules positioned within the housing, wherein at least two of the plurality of battery modules are connected in series and located on the opposite sides of the plate.

### TECHNICAL FIELD

The present disclosure relates generally to a battery system for use in industrial equipment, and, more particularly, to a battery system for an industrial vehicle.

### BACKGROUND

Industrial operations, such as mining operations involve complex operations that require large industrial machines, and machine operators to undertake challenging tasks in often dangerous environments. Typical industrial machines used in mining include continuous miners, feeder breakers, roof bolters, utility vehicles for mining, load-haul-dump (LHD) vehicles, underground mining loaders and underground articulated trucks, and these machines are under significant stress during everyday mining operations. For example, such mining machines may be subject to rocks falling onto the machine or the complete collapse or cave-in of a mine wall or roof onto the machine. In the case where significant amounts rock or other material has fallen onto the machine, components of the machine are at high risk of damage. The potential for injury of a machine operator from component damage, engine difficulties, or component fires caused by damage from falling rocks is high, and damage to a mining machine or other engine difficulties may indefinitely immobilize the machine, preventing the removal of the machine from the dangerous mining environment. These risks are amplified when utilizing a battery powered industrial vehicle that requires high voltages to operate.

A vehicle or similar industrial machine is normally provided with a bucket, container or other type of work implement for carrying/transporting a load. Such industrial vehicles require substantially greater power than conventional cars or trucks. For example, in connection with transportation of heavy loads, e.g. in contracting work, industrial vehicles are frequently used. An industrial vehicle may be operated with large and heavy loads in areas where there are no roads, for example for transports in connection with road or tunnel building, sand pits, mines and similar environments, which often requires higher torque output to the wheels to navigate such environments.

Industrial vehicles for underground mining operations, such as haulers for room and pillar type mining, may be powered by large battery systems carried on the vehicles. Such a battery system may include a housing containing an array of electrochemical cells, allowing the vehicle to travel without cords throughout a mine for a limited period of time. Such battery systems require high voltages to power mining vehicles, and the high operating voltages of these battery systems create added risk to battery failures. Battery systems for industrial vehicles need to be stored within the vehicle to optimize safety, control, and serviceability, and account for the added risks associated with operating at high voltages.

The battery housing assembly and associated battery systems according to this disclosure address one or more of the challenges set forth above and/or other problems in the art. The scope of the current disclosure, however, is defined by the attached claims, and not by the ability to solve any specific problem.

### SUMMARY

This disclosure relates generally to the field of industrial vehicles. More specifically the present disclosure relates to systems, methods, and devices for housing, accessing, controlling, and monitoring a battery assembly for use with an industrial vehicle, such as a battery-powered, underground load-haul-dump machine.

In one example, a battery housing assembly may be provided in an industrial vehicle, and the battery housing assembly may include a battery housing having a top, bottom, and opposite sides, and a length, a width, and a height, the length and width extending between the opposite sides, and the height extending from the top to the bottom of the battery housing; a plate extending substantially the entire length and height of the battery housing; and a plurality of battery modules positioned within the housing, wherein at least two of the plurality of battery modules are connected in series and located on the opposite sides of the plate.

The battery housing assembly may include one or more of the following features. The plate may be a steel plate with a width between 4 mm and 12 mm. The plate may be centrally located about the width of the battery housing. The battery housing may be a completely enclosed housing. The height of the battery housing assembly may be at least six feet. The battery housing assembly may also include a first battery set including eighteen battery modules of the plurality of battery modules connected in series; a second battery set including eighteen battery modules of the plurality of battery connected in series; a third battery set including eighteen battery modules of the plurality of battery connected in series; a fourth battery set including eighteen battery modules of the plurality of battery connected in series; and a fifth battery set including eighteen battery modules of the plurality of battery connected in series. The vehicle may be configured to operate using only power generated from any one of the first battery set, the second battery set, the third battery set, the fourth battery set, and the fifth battery set. The first battery set, the second battery set, the third battery set, the fourth battery set, and the fifth battery set may be connected in parallel. The first battery set may be connected to a first disconnect switch; the second battery set may be connected to a second disconnect switch; the third battery set may be connected to a third disconnect switch; the fourth battery set may be connected to a fourth disconnect switch; and the fifth battery set may be connected to a fifth disconnect switch. Each of the first disconnect switch, the second disconnect switch, the third disconnect switch, the fourth disconnect switch, and the fifth disconnect switch may be positioned above the plurality of battery modules. The first battery set may be positioned entirely on a first side of the plate and the second battery set may be positioned entirely on a second side of the plate, and the second side may be opposite the first side. The battery housing assembly may also include a first tray and a second tray each positioned on a shelf within the battery housing, a first plurality of battery modules of the plurality of battery modules may be positioned within the first tray and a second plurality of battery modules of the plurality of battery modules may be positioned within the second tray, and each of the first tray and the second tray may be slidable relative to a shelf of the battery housing. The industrial vehicle may be a load-haul-dump (LHD) vehicle. The battery housing assembly may be positioned at a rear portion of the LHD vehicle. The battery housing assembly may be positioned within a rear portion of the vehicle rearward of each of vehicle's wheels.

In other examples, a battery housing assembly may be provided in an industrial vehicle, and the battery housing assembly may include a battery housing having a top, bottom, and opposite sides, and a length, a width, and a height, the length and width extending between opposite sides, and the height extending from the top to the bottom of the battery housing; a plate extending substantially the entire length and height of the battery housing; a plurality of battery modules positioned within the housing, wherein a first plurality of battery modules are connected in series and a second plurality of battery modules are connected in series; a first contactor positioned at the top of the battery housing and connected to a negative terminal of the first plurality of battery modules; and a second contactor positioned at the top of the battery housing and connected to a positive terminal of the first plurality of battery modules, wherein the plate extends between the first contactor and the second contactor.

The battery housing assembly may include one or more of the following features. The battery housing assembly may also include a third plurality of battery modules are connected in series; a third contactor positioned at the top of the battery housing and connected to a negative terminal of the second plurality of battery modules; a fourth contactor positioned at the top of the battery housing and connected to a positive terminal of the second plurality of battery modules; a fifth contactor positioned at the top of the battery housing and connected to a negative terminal of the third plurality of battery modules; a sixth contactor positioned at the top of the battery housing and connected to a positive terminal of the third plurality of battery modules. The first contactor, the third contactor, and the fifth contactor may be positioned on a first side of the plate; the second contactor, the fourth contactor, and the sixth contactor may be positioned on a second side of the plate; and the first side may oppose the second side. The battery housing assembly may include a first set of cables connected to the first plurality of battery modules, and a portion of the first set of cables may extend along a first end of the battery housing.

In other examples, a battery housing assembly may be provided in an industrial vehicle. The battery housing assembly may include a battery housing having a top, bottom, and opposing sides, and a length, a width, and a height, the length and width extending between opposing sides, and the height extending from the top to the bottom of the battery housing; a first battery set including a plurality of battery modules connected in series and positioned within the battery housing; a second battery set including a plurality of battery modules connected in series and positioned within the housing; a first disconnect switch positioned at the top of the battery housing and configured to disconnected the first battery set upon actuation of the first disconnect switch; and a second disconnect switch positioned at the top of the battery housing and configured to disconnected the second battery set upon actuation of the second disconnect switch. The first disconnect switch and the second disconnect switch may be grouped together at a middle of the length of the battery housing; the first disconnect switch may be connected to two battery modules of the first battery set; and the second disconnect switch may be connected to two battery modules of the second battery set.

### BRIEF DESCRIPTION OF THE DRAWINGS

FIG. 1 shows a perspective view of a load-haul-dump machine, according to an exemplary embodiment.

FIG. 2 shows a battery system positioned within the load-haul-dump machine of FIG. 1, according to an exemplary embodiment.

FIG. 3 shows internal components of the battery system of FIG. 2.

FIG. 4 shows a side view of a portion of the battery system from FIG. 3.

FIG. 5 shows a perspective view of a portion of the battery system of FIG. 3.

FIG. 6 shows a top view of a portion of the battery system from FIG. 3.

FIG. 7 shows a top view of a portion of the battery system from FIG. 3 with a housing panel removed.

FIG. 8 shows a side view of a portion of the battery system from FIG. 3.

FIG. 9 shows a perspective view of a portion of the battery system from FIG. 3.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. In addition, in this disclosure, relative terms, such as, for example, “about,” “generally, “substantially,” and “approximately” are used to indicate a possible variation of ±10% in the stated value.

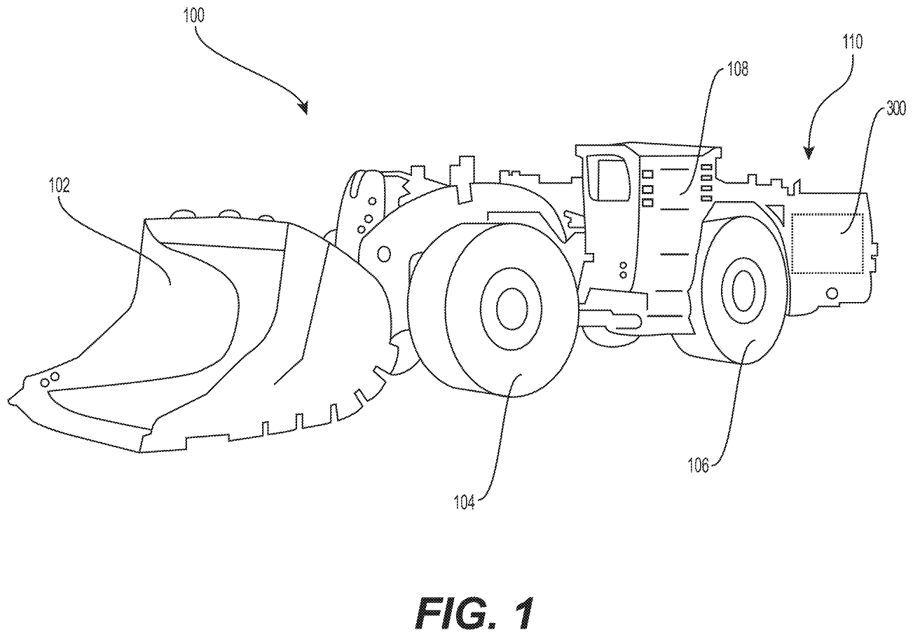

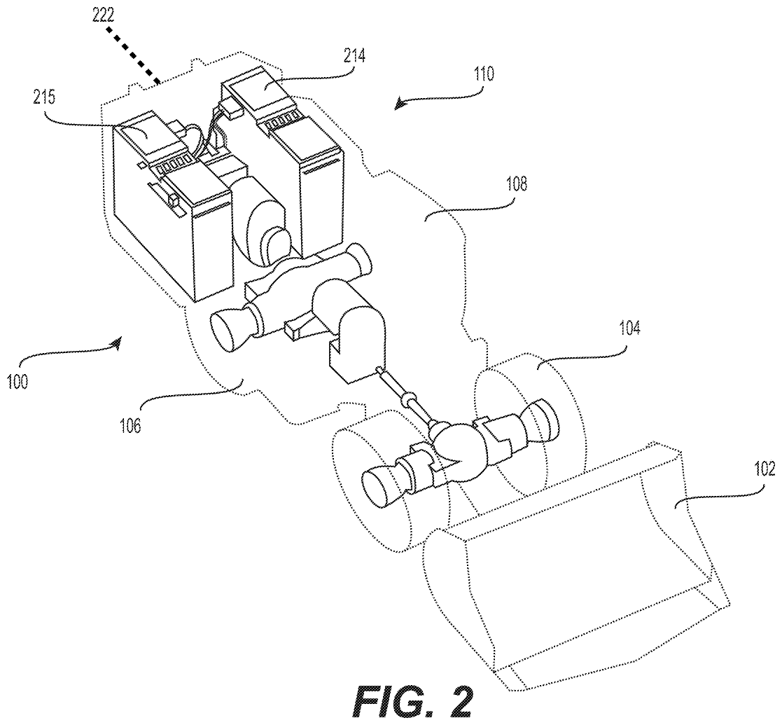

FIG. 1 shows an exemplary industrial vehicle in the form of a load-haul-dump (LHD) vehicle 100 including dump bucket 102, wheels 104, 106, operator control cabin 108, and vehicle body 110. While the discussion hereinbelow relates to attributes of an LHD vehicle 100, any of the systems and devices discussed herein may be utilized in any type of industrial vehicle known in the art, such as continuous miners, feeder breakers, roof bolters, utility vehicles for mining, underground mining loaders, underground articulated trucks, or any other vehicle used for industrial purposes, such as hauling, excavating, drilling, loading, dumping, compacting, etc. Vehicle 100 may also include a battery system 300. FIG. 2 shows an alternative view of vehicle 100 including battery system 300 including battery boxes 214, 215. As shown in FIG. 2, battery boxes 214, 215 are positioned within a rear portion of vehicle body 110, behind operator control cabin 108 and wheels 104, 106. Battery boxes 214, 215 may consume a significant amount of space within a rear portion of vehicle 100, and may have dimensions of several feet in height, length, and width. In some examples, each battery box 214, 215 may be approximately 5.5 feet tall, approximately 7 feet long, and approximately 2 feet wide. Batteries within battery boxes 214, 215 may supply power to one or more of the systems of vehicle 100, such as systems to power wheels 104, 106 and systems to move dump bucket 102. Battery system 300 of vehicle 100 may include battery boxes 214, 215 positioned on opposing sides of a central longitudinal axis 222 of vehicle 100, with battery box 214 on a left side of vehicle 100 and battery box 215 on a right side of vehicle 100. By positioning battery boxes 214, 215 on opposing sides of a central longitudinal axis 222 of vehicle 100, the weight of battery boxes 214, 215 may be evenly distributed across the rear portion of vehicle 100 and separation of battery boxes 214, 215 within vehicle body 110 may mitigate damage to one of battery boxes 214, 215 when a failure or accident occurs effecting the other battery box 214, 215.

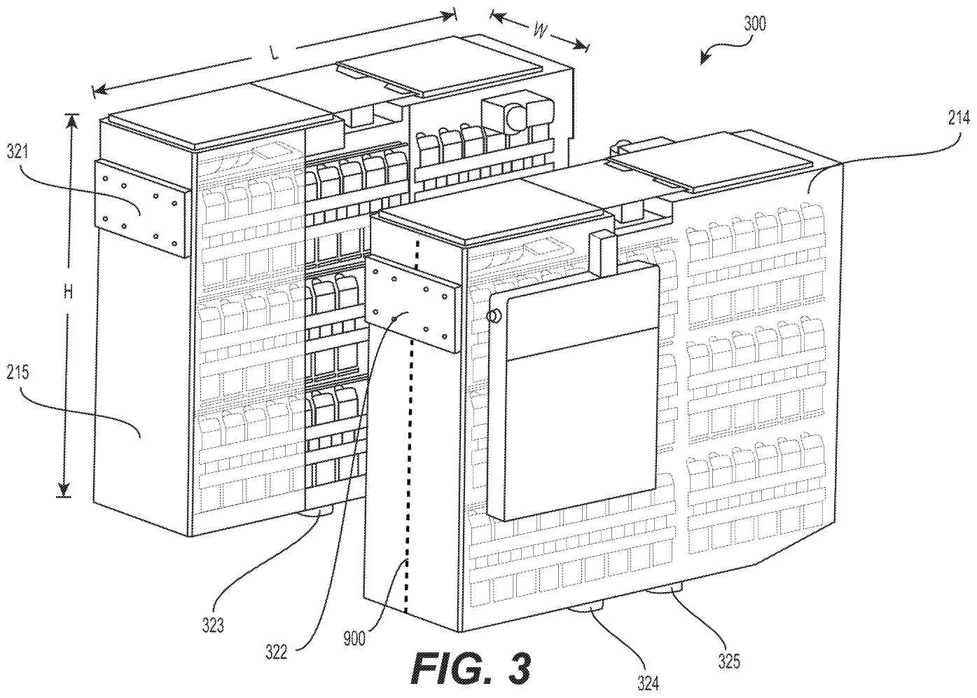

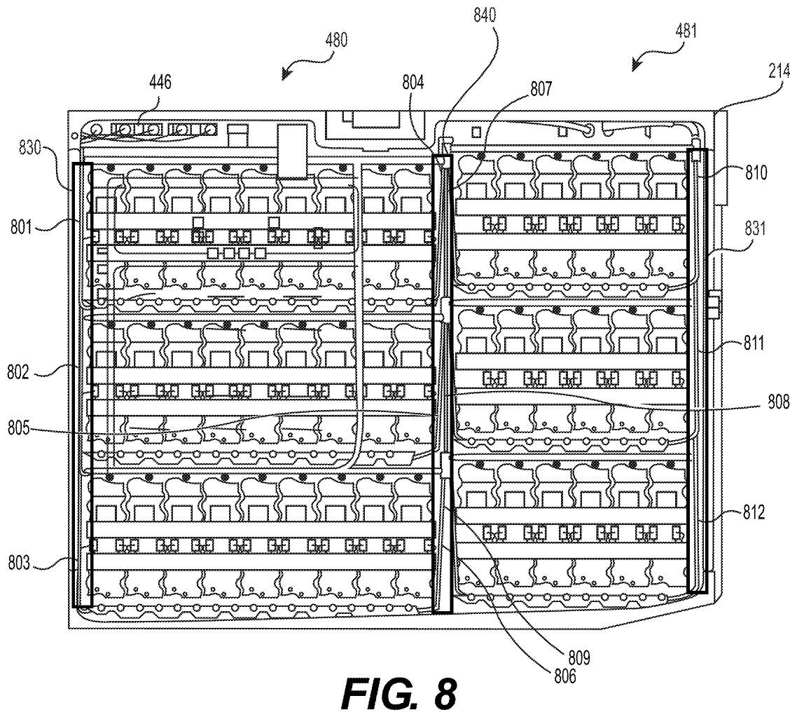

FIG. 3 illustrates an exemplary battery system 300 including battery boxes 214, 215 depicted without other aspects of vehicle 100. In FIG. 3, battery boxes 214, 215 are positioned side-by-side in the manner in which the boxes would be positioned relative to each other within vehicle 100. Battery system 300 may provide electrical power to operate vehicle 100. Battery boxes 214, 215 may include isolation mounts 321, 322, 323, 324, 325 that may be used to fasten battery boxes 214, 215 to an interior portion of vehicle body 110. Isolation mounts 321, 322, 323, 324, 325 may be positioned on an exterior surface of battery boxes 214, 215 and may separate or space battery boxes 214, 215 from other components within vehicle 100. Battery boxes 214, 215 may be sealed such that components within battery boxes 214, 215 are entirely enclosed, which may prevent unwanted material such as sand, dust, or rocks from entering battery boxes 214, 215 and preventing damage to component within battery boxes 214, 215. Each battery box 214, 215 may be sealed such that only removal of one or more components of battery box 214, 215 will allow access to the interior portion of battery box 214, 215 when the battery box 214, 215 is entirely enclosed. Battery boxes 214, 215 may include removable panels to allow access to components within battery boxes 214, 215. Dotted line 900 is representative of the relative position of plate 771 (FIG. 7) within battery box 214, extending along the height and length of battery box 214 through a central portion of battery box 214, dividing battery box 214 into two sides.

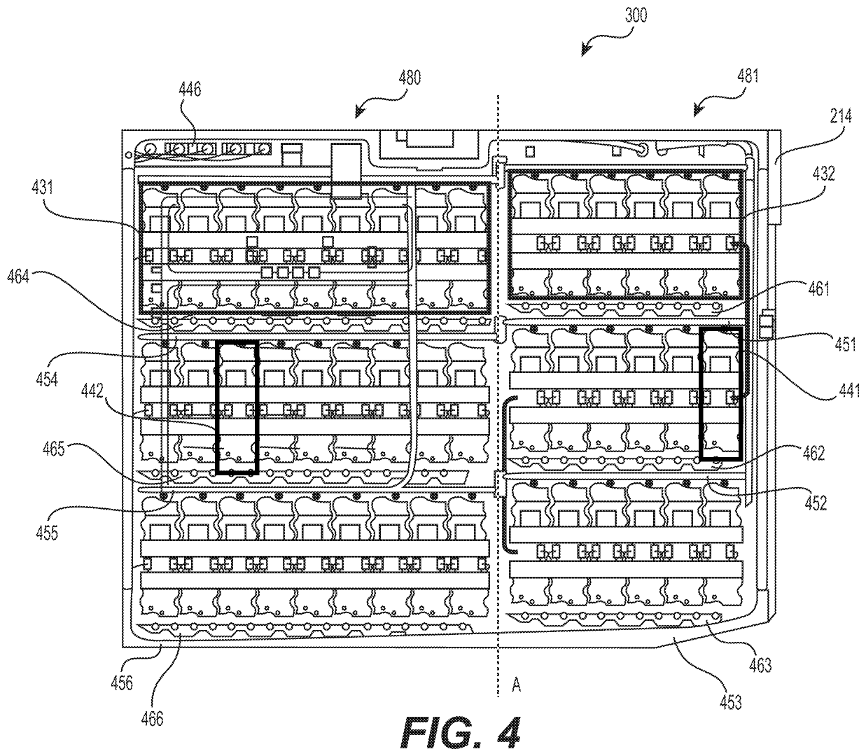

FIG. 4 illustrates the internal structure of battery box 214. Each of battery boxes 214, 215 of battery system 300 may have the internal components shown in FIG. 4. Battery system 300 may include all of the components shown in FIG. 4, and all of the components within battery box 215 (not shown) such that the components within each battery box 214, 215 function as a single system. For example, battery system 300 may include a single battery box 215, two battery boxes 214, 215, or more than two battery boxes 214, 215. A plurality of battery modules 441, 442 may be positioned in battery box 214. While only two battery modules 441, 442 are identified by a reference number in FIG. 4, each battery box 214, 215 may include 90 battery modules with 45 battery modules positioned on each side of plate 771. Forty-five battery modules 441, 442 are shown in FIG. 4. A battery module 441, 442 may include a plurality of battery cells within each battery module 441, 442. In some examples, each battery module 441, 442 may include 12 battery cells connected in series. Each battery module 441, 442 may have the following specifications: 39.4 nominal voltage, 30 Amp hours capacity, and 1.188 kilowatt hours capacity. Battery modules 441, 442 may be liquid cooled, may include one or more sensors to monitor the voltage and temperature of the module, and may include integrated resistive cell balancing.

Battery box 214 may divided into two sides by a central plate 771 (shown in FIGS. 3 and 7) extending through the entire length L and height H of battery box 214, and dividing the width W of battery box 214 in half. FIG. 4 shows the configuration of battery modules 441, 442 on a first side of battery box 214, and a second side (not shown) of battery box 214 may be on an opposing side of plate 771. The second side of battery box 214 may mirror the configuration of the first side of battery box 214. Each side of battery box 214 may include two sections 480, 481 that may be separated by axis A shown in FIG. 4. In some examples, battery modules 441, 442 may be arranged in rows extending across the length of battery box 214. A first section 480 may include three rows 431 of nine battery modules 441, 442, and a second section 481 may include three rows 432 of six battery modules 441, 442.

As shown in FIG. 4, battery box 214 may include six shelves 451-456 on each side of plate 771 configured to hold battery modules 441, 442. Shelves 454, 455, 456 each may be configured to hold a row 431 of nine battery modules 441, 442 and shelves 451, 452, 453 may each be configured to hold a row 432 of six battery modules 441, 442. Shelves 451, 452, 453, may be offset vertically (in the H dimension) and shorter in length (in the L dimension) from shelves 454, 455, 456. Battery modules 441, 442 may be positioned on trays 461, 462, 463, 464, 465, 466 that are slideable on and off shelves 451, 452, 453, 454, 455, 456 to provide easy access to battery modules 441, 442 for repair or replacement. Trays 464, 465, 466 positioned on shelves 454, 455, 456 may be configured to hold nine battery modules, and trays 461, 462, 463 positioned on shelves 451, 452, 453 may be configured to hold six battery modules. The same configuration of shelves and trays may be on the opposing side of plate 771 within battery box 214. In some examples, bus bars may connect the battery modules 441, 442 to each other.

Each battery box 214, 215 may include five battery strings. Each battery string may include eighteen battery modules connected in series with each other. Each string of battery modules 441, 442 may have the specifications of 712 nominal voltage, 30 Amp hours capacity, and 21.3 kilowatt hours capacity. Vehicle 100 may be configured to operate by utilizing the power generated by only one battery string of 18 battery modules 441, 442 connected in series. Each battery box 214, 215 may include five battery strings of eighteen battery modules 441, 442. Within battery box 214, each battery string may be connected to each other in parallel, and the power specification of the five battery strings connected in parallel may be 712 nominal voltage, 150 Amp hours capacity, and 106.5 kilowatt hours capacity. Each of the five strings of eighteen battery modules in battery box 214 may have an independent battery management unit and an independent control circuit connected to the string of eighteen battery modules. In some examples, each independent battery management unit may be a control unit configured to monitor one or more of the total voltage of the battery module, voltages of individual cells, minimum and maximum cell voltage, average temperature, coolant intake temperature, coolant output temperature, temperatures of individual cells, state of charge of the battery module or the individual cells, state of power of the battery module, current in or out of the battery module or the individual cells of the battery module, or any other parameter known in the art.

Contactors 446, 447 may be connected to each of the five battery strings in battery box 214. Contactors 446, 447 and other high-voltage components may be positioned at a top portion of battery box 214. By positioning high-voltage components at a top portion of battery box 214, the lower portion of battery box 214 may be accessed to conduct maintenance and repair on battery box 214 without a technician having to be close to the dangerous high voltage components of system 300. Each of the five battery strings in battery box 214 may be connected to a contactor 446, 447 at a negative terminal of the battery string and a separate contactor at a positive terminal of the battery string. In some examples, each contactor 446, 447 may be connected to two different battery modules 441, 442 of a battery string.

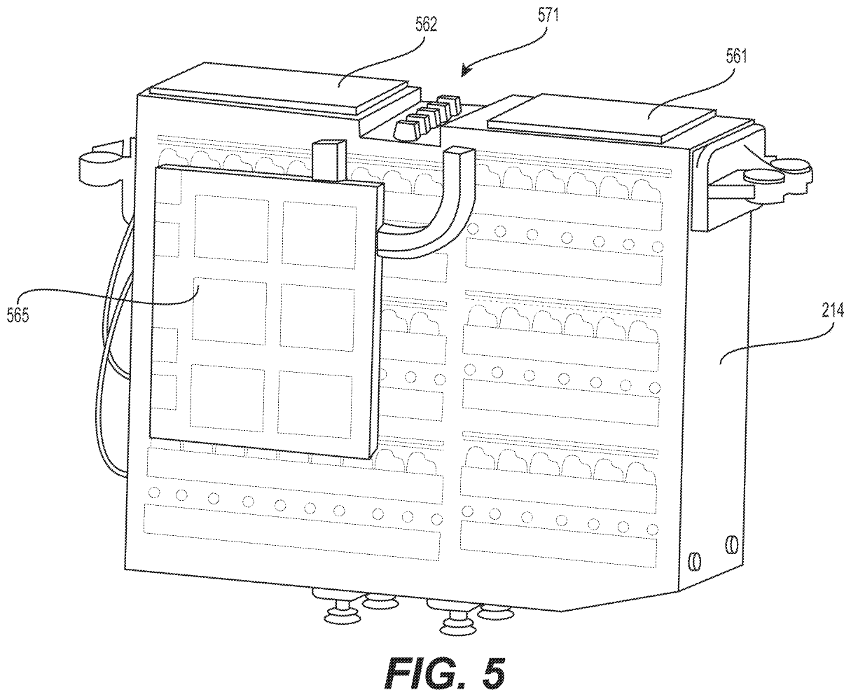

FIG. 5 illustrates battery box 214 with a side panel removed and controller 565 connected to the battery system 300. Controller 565 may be a low voltage controller, for example a controller operated at 24 volts. By separating the low voltage controller 565 from the high voltage components at the top of battery box 214, the battery system 300 may be repaired and/or maintenance on the system 300 may be conducted without a technician having to be close to the dangerous high voltage components of system 300. Removable access panels 561, 562 provide access to the high voltage components at the top of battery box 214. Upper panels 561, 562 provide access to high voltage components of battery system 300 at a top portion of battery box 214, and side panels (not shown) provide access to low voltage components such as controller 565. Disconnect switches 571 may be positioned at the top of battery box 214. Each battery string of the five battery strings within battery box 214 may have a disconnect switch 571. By actuating a disconnect switch 571, the respective battery string may be disconnected. In some examples, a disconnect switch 571 may include a removable component that disconnects the respective battery string with the removable component is removed from battery box 214. In other examples, disconnect switch 571 may be a switch that may include a first position and a second position, and the first position may connect the respective battery string and the second position may disconnect the respective battery string.

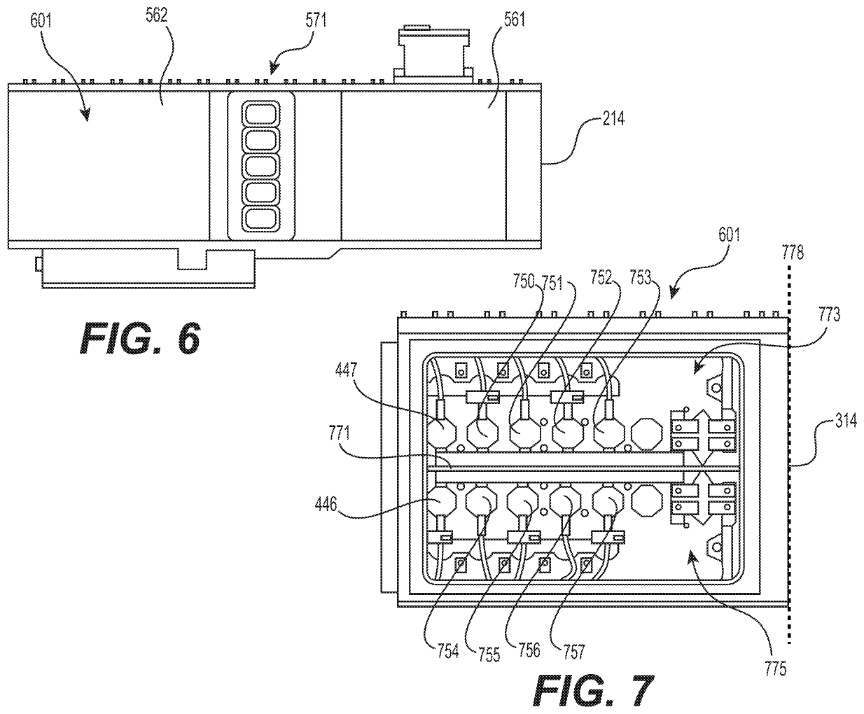

FIG. 6 shows a top view of battery box 214 with removable panels 561, 562 and disconnect switches 571. Top portion 601 includes high voltage components of battery system 300. Top portion 601 of battery box 214 is shown in FIG. 7 with panel 562 removed and the other portions outside of portion 601 of battery box 214, to the right of axis 778, omitted. As shown in FIG. 7, plate 771 extends through a central portion of battery box 214 and separates the interior portion of battery box 214 into two sides 773, 775. A first set of contactors 447, 750-753 may be connected to positive terminals of each of the five battery strings of 18 battery modules 441, 442, respectively, and a second set of contactors 446, 754-757 may be connected to negative terminals of each of the five battery strings of 18 battery modules 441, 442. The first set of contactors 447, 750-753 connected to positive terminals of battery modules 441, 442 may be positioned on first side 773 of battery box 214 and the second set of contactors 446, 754-757 connected to negative terminals of battery modules 441, 442 may be positioned on second side 775 by plate 771. Plate 771 may extend in the direction of the height H of battery box 214 such that plate 771 extends above each contactor 446, 447, 750-757 and provides a physical separation between contactors 446, 754-757 connected to negative terminals of battery modules 441, 442 and contactors 447, 750-753 connected to positive terminals of battery modules 441, 442. By physically separating contactors 446, 754-757 connected to negative terminals and contactors 447, 750-753 connected to positive terminals, plate 771 provides safety for a technician accessing battery modules 441, 442 or other components of battery system 300 by preventing unwanted connection between positive and negative terminals of battery modules 441, 442. For example, the physical barrier of plate 771 between positive and negative battery terminals may prevent the accidental connection of a positive terminal and a negative terminal of battery modules 441, 442, such as by blocking a tool from connecting positive and negative terminals.

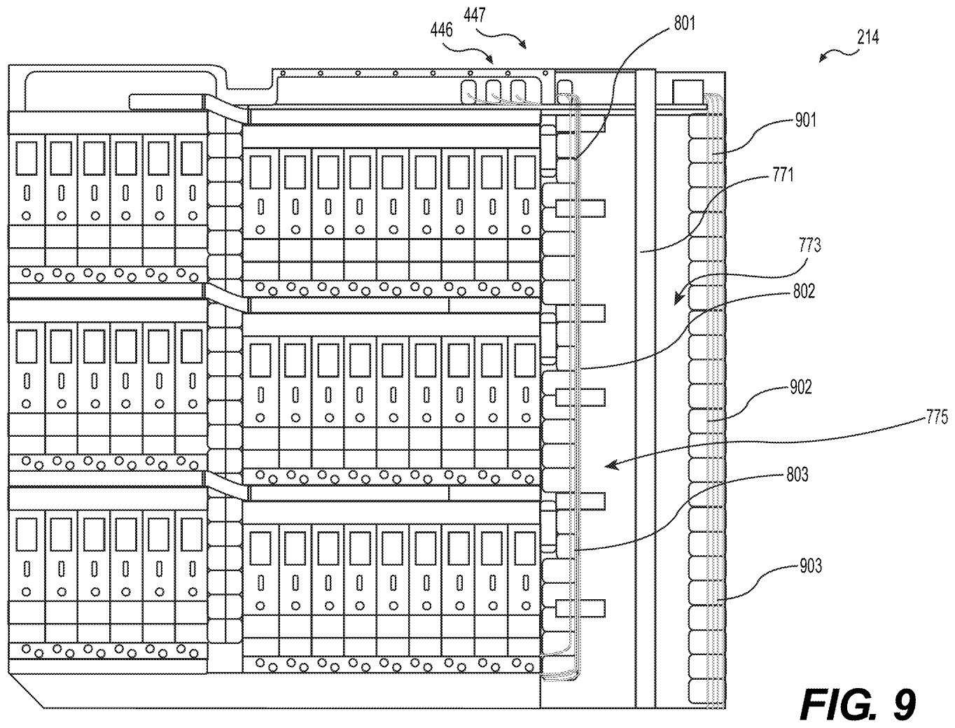

Wiring connecting the first set of contactors 447, 750-753 to positive terminals of each of the five battery strings of 18 battery modules 441, 442 may be physically separated or spaced by the plate 771 from wiring connecting the second set of contactors 446, 754-757 to negative terminals of battery modules 441, 442. In some examples, wiring connecting the first set of contactors 447, 750-753 to positive terminals of each of the five battery strings of 18 battery modules 441, 442 may extend along a first side 773 of battery box 214, and wiring connecting the second set of contactors 446, 754-757 to negative terminals of battery modules 441, 442 may extend along a second side 775 of battery box 214 opposite the first side. In other examples, wiring connecting the first set of contactors 447, 750-753 to positive terminals of each of the five battery strings of 18 battery modules 441, 442 may extend along a first side 773 of battery box 214, and wiring connecting the second set of contactors 446, 754-757 to negative terminals of battery modules 441, 442 may be positioned within an interior portion of battery box 214 spaced from the sides of battery box. The relative positions of wiring components is discussed below in relation to FIGS. 8 and 9.

Plate 771 extends through a central, longitudinal portion of battery box 214 to provide structural support to battery box 214. Plate 771 also provides safety for a technician accessing battery modules within a side 773, 775 of battery box 214 by separating the positive battery connections on side 773 from the negative battery connections on side 775. In some examples, plate 771 may be a steel plate and/or may be 8 mm thick. Plate 771 may prevent battery box 214 from crushing from the force exerted by falling rocks or other debris in a mining environment, and provides additional structural safety to address the hazards of a mining environment.

FIG. 4 illustrates the internal structure of battery box 214, and specifically shows a configuration of the wiring connecting the first set of contactors 447, 750-753 to positive terminals of each of the five battery strings of 18 battery modules 441, 442 and wiring connecting the second set of contactors 446, 754-757 to negative terminals of battery modules 441, 442. Positive terminal wiring 801-803, 810-812 may extend along a first side 830 and a second side 831 of battery box 214. Negative terminal wiring 804-809 may extend through an interior portion 840 of battery box 214 and may be spaced from positive terminal wiring 801-803, 810-812. Interior portion 840 of battery box 214 may extend along axis A and may, in some examples, be between first section 480 and second section 481. In other examples, positive terminal wiring may extend through interior portion 840 and negative terminal wiring may extend along first side 830 and second side 831. In some examples, each group of wiring 801-812 may have the same electric potential, respectively. Spacing positive terminal wiring 801-803, 810-812 from negative terminal wiring 804-809 may help avoid unwanted circuit completions or unwanted contact between positive terminal wiring 801-803, 810-812 and negative terminal wiring 804-809, and thus may help avoid hazardous circuit completions between battery wiring while a technician services battery box 214. In case of damage to the outer structure of battery box 214 and/or damage to wiring 801-812, spacing positive terminal wiring 801-803, 810-812 from negative terminal wiring 804-809 may reduce the likelihood of an electrical connection between wiring having a large difference in electrical potential.

FIG. 9 shows a perspective view of battery box 214 including plate 771 separating first side 773 from second side 775. As shown in FIG. 9, first side 773 may be on an opposite side of plate 771 as second side 775. Wiring 901-903 may extend along first side 773 of plate 771 and wiring 801-803 may extend along second side 775 of plate 771. Plate 771 may separate wiring 901-903 from wiring 801-803, and may prevent unwanted contact between wiring 901-903 and wiring 801-803. Wiring 801-803 may be connecting battery modules on second side 775 to contactors 446, and wiring 901-903 may be connecting battery modules on first side 773 to contactors 447. In some examples, wiring 801-803 may be connecting positive terminals of battery modules to contactors 446, and wiring 901-903 may be connecting negative terminals of battery modules to contactors 447. Both wiring 801-803 and wiring 901-903 may be positioned at the same end of battery box 214, however wiring 801-803 may be physically separated from wiring 901-903 by plate 771. As a result of the configuration shown in FIG. 9, wiring groups 801-803, 901-903 are grouped together on opposite sides of plate 771 so that each group has the same electrical potential. In case of damage to the outer structure of battery box 214 and/or damage to wiring 801-803, 901-903, the likelihood of an electrical connection between wring having a large difference in electrical potential is reduced.

### INDUSTRIAL APPLICABILITY

The battery system 300 of the present disclosure including two battery boxes 214, 215 is specifically designed to operate in an industrial environment, and includes features to address the unique hazards and accessibility issues associated with operating a battery-powered vehicle within an industrial environment. For example, industrial vehicles require significant amounts of power to operate, and thus very large battery assemblies are often required to operate the machine effectively. Battery system 300 is capable of outputting 213 kilowatt hours of power. Dividing the large battery system 300 into two separate, sealed containers increases the safety of operating the industrial vehicle and mitigates potential failures by not concentrating the entire battery assembly in a single housing. By positioning high voltage components of battery system 300 at a top portion of battery boxes 214, 215 a technician or other person may access the interior portion of each battery box 214, 215 without coming close to or into contact with dangerous high voltage components of the battery system 300. For example, by positioning the six groupings (e.g. rows 431, 432) of battery modules 441, 442 on removable trays 461-466 within shelves 451-456 at a lower portion of battery boxes 214, 215, a technician may easily remove one of trays 461-466 to access a row 431, 432 of battery modules 441, 442 without coming close to dangerous high voltage components positioned at the top of battery boxes 214, 215. Furthermore, incorporating central plate 771 extending through a central portion of each battery box 214, 215 provides structural support to the battery box and reduces the likelihood of damage to battery system 300 if rocks or other debris fall or otherwise come into contact with battery system 300 while vehicle 100 is operated within an industrial environment. In addition, plate 771 provides separation between positive connections of battery modules on a first side 773 of each battery box 214, 215 and negative connections of battery modules on a second side 775 of each battery box 214, 215 which prevents unwanted voltage connection between batteries and provides additional safety for a technician while accessing battery system 300.

It will be apparent to those skilled in the art that various modifications and variations can be made to the disclosed battery assembly without departing from the scope of the disclosure. Other embodiments of the battery assembly will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

We claim:

1. A battery housing assembly provided in an industrial vehicle, the battery housing assembly comprising:
a battery housing having a top, bottom, and opposite sides, and a length, a width, and a height, the length and width extending between the opposite sides, and the height extending from the top to the bottom of the battery housing;
a plate extending substantially the entire length and height of the battery housing; and
a plurality of battery modules positioned within the housing, wherein at least two of the plurality of battery modules are connected in series and located on the opposite sides of the plate

2. The battery housing assembly of claim 1, wherein the plate is a steel plate with a width between 4 mm and 12 mm.

3. The battery housing assembly of claim 1, wherein the plate is centrally located about the width of the battery housing.

4. The battery housing assembly of claim 1, wherein the battery housing is a completely enclosed housing.

5. The battery housing assembly of claim 1, wherein the height is at least six feet.

6. The battery housing assembly of claim 1, further comprising:
a first battery set including eighteen battery modules of the plurality of battery modules connected in series;
a second battery set including eighteen battery modules of the plurality of battery connected in series;
a third battery set including eighteen battery modules of the plurality of battery connected in series;
a fourth battery set including eighteen battery modules of the plurality of battery connected in series; and
a fifth battery set including eighteen battery modules of the plurality of battery connected in series.

7. The battery housing assembly of claim 6, wherein the vehicle is configured to operate using only power generated from any one of the first battery set, the second battery set, the third battery set, the fourth battery set, and the fifth battery set.

8. The battery housing assembly of claim 6, wherein the first battery set, the second battery set, the third battery set, the fourth battery set, and the fifth battery set are connected in parallel.

9. The battery housing assembly of claim 6, wherein:
the first battery set is connected to a first disconnect switch;
the second battery set is connected to a second disconnect switch;
the third battery set is connected to a third disconnect switch;
the fourth battery set is connected to a fourth disconnect switch; and
the fifth battery set is connected to a fifth disconnect switch.

10. The battery housing assembly of claim 9, wherein each of the first disconnect switch, the second disconnect switch, the third disconnect switch, the fourth disconnect switch, and the fifth disconnect switch is positioned above the plurality of battery modules.

11. The battery housing assembly of claim 6, wherein the first battery set is positioned entirely on a first side of the plate and the second battery set is positioned entirely on a second side of the plate, wherein the second side is opposite the first side.

12. The battery housing assembly of claim 1, further comprising a first tray and a second tray each positioned on a shelf within the battery housing, wherein a first plurality of battery modules of the plurality of battery modules are positioned within the first tray and a second plurality of battery modules of the plurality of battery modules are positioned within the second tray, wherein each of the first tray and the second tray is slidable relative to a shelf of the battery housing.

13. The battery housing assembly of claim 1, wherein the industrial vehicle is a load-haul-dump (LHD) vehicle.

14. The battery housing assembly of claim 13, wherein the battery housing assembly is positioned at a rear portion of the LHD vehicle.

15. The battery housing assembly of claim 1, wherein the battery housing assembly is positioned within a rear portion of the vehicle rearward of each of vehicle's wheels.

16. A battery housing assembly provided in an industrial vehicle, the battery housing assembly comprising:
a battery housing having a top, bottom, and opposite sides, and a length, a width, and a height, the length and width extending between opposite sides, and the height extending from the top to the bottom of the battery housing;
a plate extending substantially the entire length and height of the battery housing;
a plurality of battery modules positioned within the housing, wherein a first plurality of battery modules are connected in series and a second plurality of battery modules are connected in series;
a first contactor positioned at the top of the battery housing and connected to a negative terminal of the first plurality of battery modules; and
a second contactor positioned at the top of the battery housing and connected to a positive terminal of the first plurality of battery modules, wherein the plate extends between the first contactor and the second contactor.

17. The battery housing assembly of claim 16, further comprising:
a third plurality of battery modules are connected in series;
a third contactor positioned at the top of the battery housing and connected to a negative terminal of the second plurality of battery modules;
a fourth contactor positioned at the top of the battery housing and connected to a positive terminal of the second plurality of battery modules;
a fifth contactor positioned at the top of the battery housing and connected to a negative terminal of the third plurality of battery modules;
a sixth contactor positioned at the top of the battery housing and connected to a positive terminal of the third plurality of battery modules;
wherein the first contactor, the third contactor, and the fifth contactor are positioned on a first side of the plate; and
wherein the second contactor, the fourth contactor, and the sixth contactor are positioned on a second side of the plate; wherein the first side opposes the second side.

18. The battery housing assembly of claim 16, further comprising a first set of cables connected to the first plurality of battery modules, wherein a portion of the first set of cables extends along a first end of the battery housing.

19. A battery housing assembly provided in an industrial vehicle, the battery housing assembly comprising:
a battery housing having a top, bottom, and opposing sides, and a length, a width, and a height, the length and width extending between opposing sides, and the height extending from the top to the bottom of the battery housing;
a first battery set including a plurality of battery modules connected in series and positioned within the battery housing;
a second battery set including a plurality of battery modules connected in series and positioned within the housing;
a first disconnect switch positioned at the top of the battery housing and configured to disconnected the first battery set upon actuation of the first disconnect switch; and
a second disconnect switch positioned at the top of the battery housing and configured to disconnected the second battery set upon actuation of the second disconnect switch.

20. The battery housing assembly of claim 19, wherein the first disconnect switch and the second disconnect switch are grouped together at a middle of the length of the battery housing;
wherein the first disconnect switch is connected to two battery modules of the first battery set; and
wherein the second disconnect switch is connected to two battery modules of the second battery set.
